(19) United States
(12) Patent Application Publication
(10) Pub. No.: US 2014/0214835 A1
(43) Pub. Date: Jul. 31, 2014

(54) SYSTEM AND METHOD FOR AUTOMATICALLY CLASSIFYING DOCUMENTS

(71) Applicants: RICHARD THOMAS OEHRLE, Pacific Grove, CA (US); Eric Allen Johnson, Boulder Creek, CA (US); Arpit Bothra, Mumbai (IN); Jason M. Brenier, Oakland, CA (US); Anna Barbara Cueni, San Francisco, CA (US); Eric Abel Morley, Ann Arbor, MI (US)

(72) Inventors: RICHARD THOMAS OEHRLE, Pacific Grove, CA (US); Eric Allen Johnson, Boulder Creek, CA (US); Arpit Bothra, Mumbai (IN); Jason M. Brenier, Oakland, CA (US); Anna Barbara Cueni, San Francisco, CA (US); Eric Abel Morley, Ann Arbor, MI (US)

(21) Appl. No.: 13/840,285

(22) Filed: Mar. 15, 2013

Related U.S. Application Data
(60) Provisional application No. 61/757,949, filed on Jan. 29, 2013.

(51) Int. Cl. G06F 17/30

(52) U.S. Cl. CPC G06F 17/30598
USPC 707/737

(57) ABSTRACT

A system and method for automatically classifying documents using an annotated topic tree is provided. A set of topics may be extracted from a document corpus such that each document in the document corpus is associated with a topic model. A sample set of documents may be selected from the document corpus during a current sampling round. The topic models associated with the sample set of documents may be annotated by human reviewers with coding information. Each coded document may be coded as ‘responsive’, ‘non-responsive’, ‘arguably responsive’, ‘null’, and/or for other codes or issues, which are related to the topic model associated with that document. An annotated topic tree may be formed based on the annotated topic model. One or more machine learning algorithms may be used to project the information in the annotated topic tree to the rest of the document corpus. A voting algorithm which may comprise a plurality of machine learning algorithms may also be used to project the sampling judgments to the rest of the document corpus. To continuously enhance the performance of automatic classification of documents, the projection results may be analyzed after each sampling round.

### CROSS-REFERENCE TO RELATED APPLICATIONS

This application claims the benefit of U.S. Provisional Patent Application Ser. No. 61/757,949, entitled “System and Method for Automatically Classifying Documents,” filed Jan. 29, 2013, the contents of which are hereby incorporated by reference in their entirety.

### FIELD

The disclosure relates to systems and methods for identifying a sample set of documents from a document corpus. The systems and methods may generate a topic tree annotated by reviewers based on the sample set, and/or project the information in the annotated topic tree across the rest of the document corpus using one or more machine learning algorithms to automatically classify those documents. The systems and methods may automatically classify un-coded documents using a voting algorithm, and/or analyze the classification results to enhance the performance of automatic classification of documents.

### BACKGROUND

Advances in computer database technology, increases in database capacity, and deeper understanding of parallelization and distributed processing have enabled storing and processing large amounts of information in a coordinated way.

Conventional systems have been developed in an attempt to organize or classify documents (e.g., electronic documents, files, data objects, etc.) in such a manner as to enable efficient document retrieval and data mining of large amounts of information. For example, individual topics may be tagged in a way that indicates how much they correlate with responsiveness or non-responsiveness. This may over-estimate how much the distinction between responsiveness and non-responsiveness depends on individual topics without regard for the possibility that indications of responsiveness and non-responsiveness can depend significantly on interactions among topics themselves. In another example, documents may be classified by defining a notion of document similarity based on a distance metric, such as the Hellinger distance D between two documents θⱼ and θₖ, where the number of topics is t, and θ_{j,i} is the weight of topic i associated with document θⱼ:

$$D ( {θ}_{j} , {θ}_{k} ) = \sqrt{\frac{1}{2} {\sum }_{i = 1}^{t} {( \sqrt{{θ}_{j , i}} - \sqrt{{θ}_{k , i}} )}^{2}}$$

If a review of a sample set S of documents yields a responsive set S_{R} and a non-responsive set S_{N}, one may use a distance measure of this kind to find similar documents—similar on an individual basis, or similar based on the centroid of a sample set (e.g., S_{R}, S_{N}).

However, in the field of electronic discovery (“e-discovery”), indicators of responsiveness do not necessarily correlate with overall topic-similarity. That is, documents that differ in responsiveness can be similar with regard to the most heavily weighted topics in ways that overwhelm the weighted difference involving responsiveness indicators.

In addition, the field of e-discovery has other distinctive properties with regard to classification. Standard measures of the quality of a classifier are recall (a measure of completeness: the percentage of desired material successfully identified) and precision (a measure of correctness: the percentage of material identified which matches the criteria in question). For example, it can be extremely useful to identify and remove material that is irrelevant or orthogonal to responsive criteria in an e-discovery matter. But the utility is greater if precision is extremely high. If precision falls, removing material identified as irrelevant or orthogonal may risk removing some material that is actually responsive. On the other hand, a system that is able to identify a very high percentage of responsive material (meaning recall is high) may be highly valuable in e-discovery even if precision falls.

In view of these shifts in the balance between precision and recall across different e-discovery problems, what is needed is to be capable of automatically tuning or adjusting the expected balance between precision, recall, and other properties of classification.

### SUMMARY

The embodiments relate to systems and methods for identifying a sample set of documents from a document corpus, generating a topic tree annotated by reviewers based on the sample set, and/or projecting the information in the annotated topic tree across the rest of the document corpus using one or more machine learning algorithms to automatically classify those documents. The systems and methods may automatically classify un-coded documents using a voting algorithm, and/or analyze the classification results to enhance the performance of automatic classification of documents.

In some embodiments, the system may include a computer that obtains topic models by extracting a set of topics from a document corpus such that each document in the document corpus is associated with a topic model. The computer may identify a sample set of documents from the document corpus during a current sampling round. The topic models associated with the sample set of documents may be annotated by human reviewers with coding information. For example, the coding information may include responsiveness, non-responsiveness, arguably responsive, null, and/or other codes for each document as related to the topic model associated with that particular document. The computer may transform the annotated topic model to an annotated topic tree. The computer may project the information in the annotated topic tree to the rest of document corpus using one or more machine learning algorithms. A voting algorithm which may comprise a plurality of machine learning algorithms may also be used to project the sampling judgments to the rest of the document corpus. In some embodiments, the computer may identify a training document set and execute one or more machine learning algorithms to automatically classify the training document set. The computer may analyze the results of automated classification of the training document set and/or update or otherwise tune the machine learning algorithms over an iterative succession of sampling.

The computer may include one or more processors configured to perform some or all of a functionality of a plurality of modules. For example, the one or more processors may be configured to execute a topic model module, a sampling module, a projection module, an analysis module, and/or other modules.

The topic model module may be configured to obtain topic models by extracting a set of topics from a document corpus such that each document in the document corpus is associated with a topic model. In other words, each document may be represented as a probability distribution of a set of the automatically extracted topics.

In some embodiments, the topic model may be a ranked topic model, where a set of topics associated with each document is ordered by decreasing topic weight. In some embodiments, the topic weights may be rounded off (and if desired, re-normalized to a new probability distribution), which may have the effect of blurring distinctions among documents with similar topic distributions,

In some embodiments, the topic weights of a ranked topic model may be ignored altogether. In these embodiments, the continuous n-dimensional space of documents may be simplified to a discrete form by disregarding the information about continuous topic weights while keeping the relative order provided by the topic weights,

The sampling module may be configured to identify a sample set of documents from the document corpus. The sampling module may be configured to receive coding information from one or more human reviewers who may annotate each of the documents from the sample set with coding information. Each coded document may be coded as ‘responsive’, ‘non-responsive’, ‘arguably responsive’, ‘null’, and/or for other codes or issues. For example, if a human reviewer determines that a particular document is responsive, the document and/or the corresponding topic model (and each of the topics in the topic list) may be annotated with ‘responsive.’

In some embodiments, the sampling module may include a sub-module that may be configured to monitor quality of review conducted by human reviewers. Any system which projects the review results on a representative sample of documents across a larger document set depends critically on the quality of that review. To monitor the quality of review, the sub-module may select a parametrically selected number of documents and distribute them across a plurality of human reviewers, so that each document is reviewed two or more times by different reviewers (or in some embodiments, even the same reviewer at different times). Before projecting the sample review across the larger document set, the sub-module may check for differences among the codes assigned by different reviewers to the same reviewed documents. Such differences may be regarded as indicators of documents that are difficult to judge, of review criteria that are insufficiently clear, and/or of other factors. In some embodiments, the projection step may be disabled until conflicting codes are suitably resolved by the members of the review team.

The sampling module may be configured to transform the annotated topic model to an annotated topic tree. In some embodiments, each document of the sample set may be denoted by a particular set of prefix paths (“topic prefixes”) using the topic tree.

In some embodiments, the sampling module may be configured to label each node (e.g., each topic prefix) of the topic tree with the coding information provided by the human reviewer. The coding information provided by the human reviewer may be applied to the topic tree such that each topic prefix of the topic tree may be labeled with a tuple of numbers that indicate how many documents with the particular topic prefix in the sample set are coded for ‘responsive’, ‘non-responsive’, ‘arguably responsive’, ‘null’, etc.

The projection module may be configured to project the information in the annotated topic tree across un-sampled documents in the document corpus (and/or other documents) using one or more machine learning algorithms to automatically classify those documents. In some embodiments, the projection module may be configured to identify suitable sets of training documents and execute one or more machine learning algorithms using the annotated topic tree to automatically classify the training document sets. The results of classification of the training document sets may be provided to the analysis module for analysis of the classification results in order to update or otherwise tune the one or more machine learning algorithms over an iterative succession of sampling via the sampling module.

In some embodiments, the projection module may be configured to obtain one or more documents (“un-coded documents”) and automatically classify the one or more documents based on an annotated topic tree generated by the sampling module. The one or more un-coded documents may include documents in the document corpus not included in the sample set (“un-sampled document”), documents from the training document sets, and/or other documents.

In some embodiments, the projection module may be configured to execute one or more machine learning algorithms based on an annotated topic tree. The projection module may obtain an annotated topic tree that has been generated by the sampling module.

In some embodiments, the projection module may be configured to associate the annotated topic tree with a set of rules that may be used to classify the one or more un-coded documents. The set of rules may be defined by a user and/or automatically generated by the system. A rule may be associated with each topic prefix in the annotated topic tree and may be configured to assign a code (e.g., ‘resp’, ‘non-resp’, ‘arg resp’, ‘null’, etc.) to each un-coded document associated with the particular topic prefix. In some embodiments, a rule may specify one or more conditions that should be satisfied before assigning a code to a document.

In some embodiments, the projection module may be configured to obtain and/or identify a topic model for each un-coded document, which associates each un-coded document with one or a set of relevant topics (“topic list”) where a topic list may include a list of relevant topics ordered by topic weight (e.g., decreasing topic weight). In some embodiments, the projection module may identify the highest weighted topic (e.g., the first topic prefix) in the topic list and match it against the corresponding topic prefix in the annotated topic tree. If the corresponding topic prefix has a rule associated with it and the conditions of the rule (if any) are satisfied, the un-coded document may be assigned to a particular code according to the rule. Otherwise, the projection module may identify the next topic prefix (e.g., the first two highest weighted topics, the first three highest weighted topics, and so on) and match that topic prefix against the corresponding topic prefix in the coded topic tree model until the un-coded document is assigned to a particular code according to a rule associated with the corresponding topic prefix and/or the end of the topic list is reached.

In some embodiments, the projection module may be configured to apply a combination of a plurality of machine learning algorithms to the one or more un-coded documents so as to automatically classify individual documents based on a selected voting algorithm. In some embodiments, each of the plurality of machine learning algorithms may represent one voting classifier in a voting algorithm. For example, if 5 different machine learning algorithms are used for classification, a voting algorithm may include 5 voting classifiers where each voting classifier may get one vote.

The plurality of machine learning algorithms may include the one or more machine learning algorithms that may be run based on an annotated topic tree, as discussed herein. In addition, the plurality of the machine learning algorithms may include various machine learning techniques such as Stochastic Gradient Descent, Random Forests, complementary Naïve Bayes, Principal Component Analysis, Support Vector Machines (SVM), and/or other well-known machine learning algorithms, as apparent to those skilled in the art.

The projection module may be configured to select and/or execute one of several types of voting algorithms. In some embodiments, a universal voting algorithm may classify a document with a certain code only when all of the voting classifiers (e.g., machine learning algorithms) have classified the same document with that particular code. In some embodiments, a majority rule voting algorithm may classify a document with a particular code only when a majority of the voting classifiers (e.g., machine learning algorithms) has classified the same document with that code. In some embodiments, an existential document voting algorithm may classify a document with a particular code as long as at least one voting classifier (e.g., machine learning algorithm) models that document with that code.

The analysis module may be configured to analyze the projection results to enhance the performance of automatic classification of documents. In some embodiments, the analysis module may receive the results of classification of a training document set from the projection module and/or analyze the results to update or otherwise tune the machine learning algorithms over an iterative succession of sampling via the sampling module.

In some embodiments, the projection results may be produced using a plurality of machine learning algorithms defined by a selected voting algorithm. Each of the plurality of machine learning algorithms may build its own model of the training document set (and/or other document sets). In these embodiments, the analysis module may be configured to aggregate the projection results from each of the plurality of machine learning algorithms. If all machine learning algorithms (and/or a majority of machine learning algorithms) uniformly model a given document as ‘responsive’, there may be a higher probability that this document has been correctly classified as ‘responsive’. On the other hand, the documents that have been classified inconsistently by the machine learning algorithms may be designated as “dark matter”. In order to reduce the size of “dark matter” and thereby enhance the performance of the automated classification, the analysis module may use adaptive resampling techniques. In this way, classified document partition may continuously be enlarged while the size of dark matter population may be reduced through an iterative sampling.

Various other objects, features, and advantages of the embodiments will be apparent through the detailed description and the drawings attached hereto. It also is to be understood that both the foregoing general description and the following detailed description are exemplary and not restrictive of the scope of the embodiments.

### BRIEF DESCRIPTION OF THE DRAWINGS

FIG. 1 illustrates a system of automatically classifying documents using an annotated topic tree and analyzing the classification results to enhance the performance of automated classification of documents, according to one embodiment.

FIG. 2 illustrates a process for automatically classifying documents using an annotated topic tree and analyzing the classification results to enhance the performance of automated classification of documents, according to an embodiment.

FIG. 3 illustrates a process for automatically classifying documents using an annotated topic tree, according to an embodiment

FIG. 4 illustrates an exemplary topic tree, according to an embodiment.

### DETAILED DESCRIPTION

Reference is made to the figures to illustrate selected embodiments and preferred modes of carrying out the invention. It is to be understood that the invention is not hereby limited to those aspects depicted in the figures.

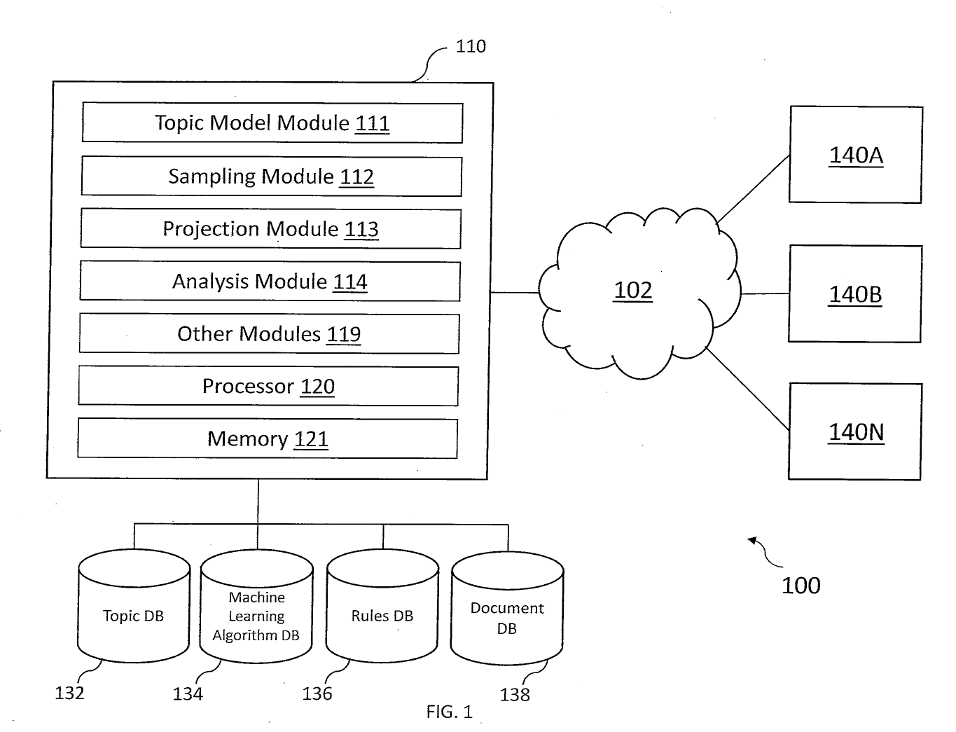

FIG. 1 illustrates a system 100 of automatically classifying documents using an annotated topic tree and analyzing the results of the automated classification, according to an aspect of the invention. System 100 may include a computer 110 and/or other components. In some embodiments, computer 110 may include one or more processors 120 configured to perform some or all of a functionality of a plurality of modules, which may be stored in a memory 121. For example, one or more processors 120 may be configured to execute a topic model module 111, a sampling module 112, a projection module 113, an analysis module 114, and/or other modules 119.

Topic model module 111 may be configured to obtain topic models by extracting a set of topics from a document corpus (which may be stored in a document database 138) such that each document in the document corpus is associated with a topic model. In other words, each document may be represented as a probability distribution of a set of the automatically extracted topics.

Topic models may be regarded as vector models of documents in a large dimensional lexical space: each word w that occurs in any of the documents in a given document collection corresponds to a dimension d_w. In a simple model, for each document D, the value of the vector v_D that models D at dimension d_w is simply the count of the number of occurrences of the word w in D. In this example, a document consisting of the sentence “police police police” would have a count of 3 in the “police” dimension and 0 in every other dimension. In some cases, the vector v_D may be a term-frequency inverse-document frequency (“tf-idf”) vector where the value of uncommon words may be weighted higher than the value of common words. In some cases, n-grams (i.e., a sequence of n words) may be used rather than individual words w.

Latent Sematic Analysis (“LSA”) arranges all the vector models into a single large dimensional matrix: the columns correspond to the dimensions associated with each word; the rows correspond to the vector models of documents. The matrix operation of Singular Value Decomposition may be applied to the dimensional matrix, which is very closely related to the statistical technique known as Principal Component Analysis. The goal of LSA is to bring to prominence “latent” semantic factors which address two dogged problems in text-based forms of search and search-based information retrieval: multiple (and often unintentional) meanings of search components (resulting in false positives in the documents retrieved) and unknown variations in meaning of terms (resulting in false negatives). Probabilistic Latent Sematic Analysis (“PSLA”) models a document as generated by a topic, where a topic is a distribution over words, using machine learning techniques to understand unknown topics associated with each document. Since a word can be associated with more than one topic, this addresses the multiple meanings (polysemy, ambiguity) problem. And it addresses the problem of unknown variation since the automated techniques that solve the generative problem treats every word in a collection on the same basis.

In topic models, as in PLSA, a topic is a probability distribution over a set of words. But a document is modeled as a probability distribution over a set of topics. This makes it possible to assign more than one topic to a document. Topic models for a collection of documents can be constructed automatically using standard statistical techniques such as latent Dirichlet allocation.

Topic models extracted or otherwise determined based on the document corpus may be stored a topic database 132. Topic model module 111 may be configured to extract a topic model associated with individual documents of the document corpus by extracting a set of topics from the expressions and/or words making up the documents, where each topic is a probability distribution over a set of words. Each document may be associated with a set of topics (“topic list”) with weights (“topic weights”) determined by the probability distribution. For example, topic models may include:

| Doc ID | topic 0 | topic 1 | topic 2 | topic 3 | topic 4 | . . . |
|---|---|---|---|---|---|---|
| 123465 | 0.01326577 | 0.00123576 | 0.16772344 | 0.02467832 | 0.00010276 | . . . |
| 123466 | 0.10326577 | 0.01032567 | 0.21572439 | 0.02746823 | 0.03012067 | . . . |

In some embodiments, the topic model may be a ranked topic model, where the topic list associated with each document is ordered by decreasing topic weight, as shown below:

| Doc ID | | | |
|---|---|---|---|
| 123465 | topic 2: 0.16772344 | topic 3: 0.02467832 | . . . |
| 123466 | topic 2: 0.21572439 | topic 0: 0.10326577 | . . . |

In some embodiments, the ranked topic model may include a top N number of topics selected based on the topic weight and/or only those topics whose associated topic weight is greater than a predefined weight threshold. In some embodiments, the topic weights may be rounded off (and if desired, re-normalized to a new probability distribution), which may have the effect of blurring distinctions among documents with similar topic distributions.

In some embodiments, the topic weights of a ranked topic model may be ignored altogether. In these embodiments, the continuous n-dimensional space of documents may be simplified to a discrete form by disregarding the information about continuous topic weights while keeping the relative order provided by the topic weights. This may reduce the set of topic lists described above to the topic lists below:

| Doc ID | | | | |
|---|---|---|---|---|
| 123abf7 | topic21 | topic13 | topic42 | topic88 |
| 123xyz8 | topic21 | topic13 | topic42 | topic88 |
| 321fb7a | topic21 | topic13 | topic11 | topic52 |
| 4857xxx | topic20 | topic13 | topic10 | topic48 |

Sampling module 112 may be configured to identify a sample set of document from the document corpus. The sample set may include a relatively small but statistically significant set of documents. Sampling module 112 may be configured to receive coding information from a human reviewer who may annotate each of the documents from the sample set with coding information. The user input and/or coding information provided by a human reviewer may be received via computer 110 and/or may be received via one of client devices 140A, B, . . . , N and communicated to computer 110. The coding information may include responsiveness, non-responsiveness, arguably responsiveness, null, and/or other codes for each document. For example, if a human reviewer determines that a particular document is responsive, the document and/or the corresponding topic model (and each of the topics in the topic list) may be annotated with ‘responsive.’

In some embodiments, sampling module 112 may include a sub-module that may be configured to monitor quality of review conducted by human reviewers. Any system which projects the review results on a representative sample of documents across a larger document set depends critically on the quality of that review. To monitor the quality of review, the sub-module may select a parametrically selected number of documents and distribute them across a plurality of human reviewers, so that each document is reviewed two or more times by different reviewers (or in some embodiments, even the same reviewer at different times). Before projecting the sample review across the larger document set, the sub-module may check for differences among the codes assigned by different reviewers to the same reviewed documents. Such differences may be regarded as indicators of documents that are difficult to judge, of review criteria that are insufficiently clear, and/or of other factors. In some embodiments, the projection step may be disabled until conflicting codes are suitably resolved by the members of the review team.

An annotated topic model may associate an annotation or code with each document, as illustrated below, using the codes ‘resp’, ‘non-resp’, ‘arg resp’, and/or ‘null’:

| Doc ID | Code | | | | |
|---|---|---|---|---|---|
| 123abf7 | resp | topic21 | topic13 | topic42 | topic88 |
| 123xyz8 | non-resp | topic21 | topic13 | topic42 | topic88 |
| 321fb7a | non-resp | topic21 | topic13 | topic11 | topic52 |
| 4857xxx | arg resp | topic20 | topic13 | topic10 | topic48 |

Sampling module 112 may be configured to transform the annotated topic model to an annotated topic tree. A tree is a graph with a unique path between any two nodes. A rooted tree is a tree with a unique designated node—the ROOT. Two distinct nodes may be connected by an edge. A path may represent any connected sequence of edges. A “prefix path” may be a path from the ROOT to any node below it. For example, for the topic list (of decreasing weighted topics), “topic21, topic13, topic42, topic88”, the ROOT may be connected to a first node representing topic21 via an edge, the topic21 node may be connected to a second node representing topic13, the topic13 node may be connected to a third node representing topic42, and the topic42 node may be connected to a fourth node representing topic88. In this example, the topic13 node (i.e., the second node) may be associated with a prefix path that may be represented as “|21|13” where each line represents an edge in the topic tree. Similarly, the topic88 node (i.e., the fourth node) may be associated with a prefix path, “|21|13|42|88”.

In some embodiments, each document of the sample set may be denoted by a particular prefix path (“topic prefix”) using the topic tree. For example, Document ‘123abf7’ of the example above may be denoted by a topic prefix such as “|21” (e.g., the first topic prefix), “|21|13” (e.g., the second topic prefix), “|21|13|42” (e.g., the third topic prefix), and/or “|21|13|42|88” (e.g., the fourth topic prefix).

In some embodiments, sampling module 112 may be configured to label each node (e.g., each topic prefix) of the topic tree with the coding information provided by the human reviewer. The coding information provided by the human reviewer may be applied to the topic tree such that each topic prefix of the topic tree may be labeled with a tuple of numbers that indicate how many documents with the particular topic prefix in the sample set are coded for ‘responsive’, ‘non-responsive’, ‘arguably responsive’, ‘null’, etc. Referring to the example above, among 3 documents (i.e., Document ‘123abf7’, Document ‘123xyz8’, and Document ‘321fb7a’) with the topic prefix, “|21”, 1 document (i.e., Document ‘123abf7’) has been determined to be responsive while 2 documents (i.e., Document ‘123xyz8’, and Document ‘321fb7a’) have been determined to be nonresponsive. In this example, that topic prefix may be associated with corresponding coding information as the following: “|21:1/2” where two codes (i.e., ‘responsive’ and ‘non-responsive’) are represented in the form ‘r/n’. Similarly, the topic prefix of “|21|13” may be denoted by “|21|13:1/2” since among 3 documents (i.e., Document ‘123abf7’, Document ‘123xyz8’, and Document ‘321fb7a’) with the topic prefix, “|21|13”, 1 document has been determined to be responsive and 2 documents have been determined to be non-responsive by the human reviewer. There are 2 documents (i.e., Document ‘123abf7’ and Document ‘123xyz8’) with the topic prefix, “|21|13|42.” Among these 2 documents, 1 document (i.e., Document ‘123abf7’) has been determined to be responsive while the other one (Le., Document ‘123xyz8’) has been determined to be non-responsive. Thus, the topic prefix of “|21|13|42” may be associated with ‘1/1’ in this example.

Projection module 113 may be configured to project the information in the annotated topic tree across un-sampled documents in the document corpus (and/or other documents) using one or more machine learning algorithms to automatically classify those documents. Machine learning algorithms are well known in the art, the specifics of which need not be described in detail herein. Any suitable machine learning algorithm may be used in the context of the embodiments, including for example, Stochastic Gradient Descent, Random Forests, complementary Naive Bayes, Principal Component Analysis, Support Vector Machines (SVM), and/or other well-known machine learning algorithms. In some embodiments, projection module 113 may be configured to identify suitable sets of training documents and execute one or more machine learning algorithms using the annotated topic tree to automatically classify the training document sets. The training document sets may include documents from the document corpus (and/or other documents). The results of classification of the training document sets may be provided to analysis module 114 for analysis of the classification results in order to update or otherwise tune the one or more machine learning algorithms over an iterative succession of sampling via sampling module 112.

In some embodiments, projection module 113 may be configured to obtain one or more documents (“un-coded documents”) and automatically classify the one or more documents based on an annotated topic tree generated by sampling module 112. The one or more un-coded documents may include documents in the document corpus not included in the sample set (“un-sampled document”), documents from the training document sets, and/or other documents.

In some embodiments, projection module 113 may be configured to execute one or more machine learning algorithms based on an annotated topic tree. Projection module 113 may obtain an annotated topic tree that has been generated by sampling module 112. In some embodiments, Projection module 113 may retrieve an annotated topic tree from topic database 132.

In some embodiments, projection module 113 may be configured to associate the annotated topic tree with a set of rules that may be used to classify the one or more un-coded documents. The set of rules may be defined by a user and/or automatically generated by the system. The set of rules may be stored in a rules database 136 and/or any other database linked to computer 110. A rule may be associated with each topic prefix in the annotated topic tree and may be configured to assign a code (e.g., ‘resp’, ‘non-resp’, ‘arg resp’, ‘null’, etc.) to each un-coded document associated with the particular topic prefix. In some embodiments, a rule may specify one or more conditions that should be satisfied before assigning a code to a document.

In some embodiments, projection module 113 may be configured to obtain and/or identify a topic model for each un-coded document, which associates one or more un-coded documents with one or a set of relevant topics (“topic list”) where a topic list may include a list of relevant topics ordered by topic weight (e.g., decreasing topic weight). In some embodiments, projection module 113 may identify the highest weighted topic (e.g., the first topic prefix) in the topic list and match it against the corresponding topic prefix in the annotated topic tree. If the corresponding topic prefix has a rule associated with it and the conditions of the rule (if any) are satisfied, the un-coded document may be assigned to a particular code according to the rule. Otherwise, projection module 113 may identify the next topic prefix (e.g., the first two highest weighted topics, the first three highest weighted topics, and so on) and match that topic prefix against the corresponding topic prefix in the coded topic tree model until the un-coded document is assigned to a particular code according to a rule associated with the corresponding topic prefix and/or the end of the topic list is reached.

For example, a rule may state that if r>0 and n=0 (meaning that there is at least one document that has been coded with ‘responsive’ for a particular topic prefix whereas there is no document coded with ‘non-responsive’), an un-coded document with the particular topic prefix may be assigned to ‘responsive’. Similarly, if r=0 and n>0, the rule may assign an un-coded document with the particular topic prefix to ‘non-responsive’. In this example, the rule may be associated with the annotated topic tree with the following topic prefixes:

|21:57/47|13:2/3|42:1/1|88:0/1

|21:57/47|13:2/3|42:1/1|63:1/0|32:1/0

Documents whose most strongly represented topic is topic 21 have been coded in a split way: approximately 55% responsive (that is 57 documents out of a total of 104 documents whose most strongly represented topic is topic 21) and 45% nonresponsive (that is 47 documents out of a total 104 documents whose most strongly represented topic is topic 21). 5 documents whose most strongly represented topic is topic 21 and second most strongly represented topic is topic 13 are also split: 2 responsive and 3 nonresponsive. Similarly, 2 documents whose third most strongly represented topic is topic 42 are also split: 1 responsive and 1 nonresponsive. However, 1 document whose fourth most strongly represented topic is topic 88 has been coded with ‘non-responsive’ in this topic tree model. According to the predefined rule, since r=0 and n>0, any un-coded documents with a topic prefix represented by “|21|13|42|88” may be assigned to ‘non-responsive’. On the other hand, 1 document whose fourth most strongly represented topic is topic 63 has been coded with ‘responsive’ in this topic tree model, which means that any un-coded documents with a topic prefix represented by “|21|13|42|63” may be assigned to ‘responsive’ according to the rule. In this example, any un-coded documents whose topic list includes only topic 21, topic 13, and/or topic 42, but no other topics may be left unclassified because the conditions for the rule have not been satisfied.

In some embodiments, projecting module 113 may be configured to apply a combination of a plurality of machine learning algorithms to the one or more un-coded documents so as to automatically classify individual documents based on a selected voting algorithm. In some embodiments, each of the plurality of machine learning algorithms may represent one voting classifier in a voting algorithm. For example, if 5 different machine learning algorithms are used for classification, a voting algorithm may include 5 voting classifiers where each voting classifier may get one vote. Voting algorithms also are well known in the art, and any suitable voting algorithm can be used in the embodiments, including for example, those disclosed in Parhami, “Voting Algorithms,” IEEE Transactions on Reliability, Vol. 43, No. 4, pp. 617-629 (1994), which discusses weighted voting schemes, including a range of threshold voting schemes, oriented toward the ‘realization of ultrareliable systems based on the multi-channel computational paradigm’ [p. 617]. There is another tradition of voting algorithms in the machine learning literature (E. Bauer and R. Kohavi, “An Empirical Comparison of Voting Classification Algorithms: Bagging, Boosting, and Variants,” Machine Learning 36, 105-139 (1999)), including Bagging (Bootstrap AGGregatING) and Boosting, and Adaptive Boosting (AdaBoost), in which a single classifier is trained multiple times with the corresponding results combined by a voting scheme to converge on a single output. The present system is compatible with these methods, but in these embodiments, votes are allocated to classifiers of different types.

The plurality of machine learning algorithms may include the one or more machine learning algorithms that may be run based on an annotated topic tree, as discussed herein. In addition, the plurality of the machine learning algorithms may include various machine learning techniques such as Stochastic Gradient Descent, Random Forests, complementary Naïve Bayes, Principal Component Analysis, Support Vector Machines (SVM), and/or other well-known machine learning algorithms, as apparent to those skilled in the art. The plurality of machine learning algorithms may be selected and/or configured by user input and/or by computer 110. Machine learning algorithms may be stored in a machine learning algorithm database 134 and/or any other database linked to computer 110.

Projection module 113 may be configured to select and/or execute one of several types of voting algorithms. In some embodiments, a universal voting algorithm may classify a document with a certain code only when all of the voting classifiers (e.g., machine learning algorithms) have classified the same document with that particular code. For example, a document may be classified as ‘responsive’ only when all of the machine learning algorithms used in the universal voting algorithm voted it as ‘responsive.’ In some embodiments, a majority rule voting algorithm may classify a document with a particular code only when a majority of the voting classifiers (e.g., machine learning algorithms) has classified the same document with that code. In a simple model, each voting classifier may get one vote. Thus, if 3 out of 5 machine learning algorithms have modeled a particular document as ‘responsive,’ the majority rule voting algorithm may classify that document as ‘responsive.’ The number of votes each voting classifier may get may be increased, decreased, or otherwise adjusted relative to each other. In some embodiments, an existential document voting algorithm may classify a document with a particular code as long as at least one voting classifier (e.g., machine learning algorithm) models that document with that code.

Analysis module 114 may be configured to analyze the projection results to enhance the performance of automatic classification of documents. In some embodiments, analysis module 114 may receive the results of classification of a training document set from projection module 113 and/or analyze the results to update or otherwise tune the machine learning algorithms over an iterative succession of sampling via sampling module 112.

In some embodiments, the projection results may be produced using a plurality of machine learning algorithms defined by a selected voting algorithm. Each of the plurality of machine learning algorithms may build its own model of the training document set (and/or other document sets). In these embodiments, analysis module 114 may be configured to aggregate the projection results from each of the plurality of machine learning algorithms as the following:

Universal document partition=universal R+universal N+dark matter

Majority rule partition=majority R+majority N+dark matter

A partition may represent the entire training document set. “Universal R” may be the first subset of the partition that all of the machine learning algorithms model as ‘responsive’, “universal N” is the second subset of the partition that all of the machine learning algorithms model as ‘non-responsive’, and “dark matter” is the rest of the partition excluding the first and second subsets. Similarly, “majority R” is the first subset of the partition that a majority of the machine learning algorithms model as ‘responsive’, “majority N” is the second subset of the partition that a majority of the machine learning algorithms model as ‘non-responsive’, and “dark matter” is the rest of the partition excluding the first and second subsets.

In these embodiments, if all machine learning algorithms (and/or a majority of machine learning algorithms) uniformly model a given document as ‘responsive’, there may be a higher probability that this document has been correctly classified as ‘responsive’. On the other hand, the documents that have been classified inconsistently by the machine learning algorithms may be designated as “dark matter”. In order to reduce the size of “dark matter” and thereby enhance the performance of the automated classification, analysis module 114 may use adaptive resampling techniques. In one adaptive resampling technique, instead of defining a random sample set from the document corpus, an incremental (and/or iterative) approach may be taken. For example, analysis module 114 may determine whether the recall of the first and second subsets of the partition is sufficiently high. If the recall is high enough, the partition may be excluded from the sample population such that the documents in the partition may not be part of the sample set of documents in the next sampling round. In another example, analysis module 114 may identify documents that are modeled uniformly by all of the machine learning algorithms and/or consistently by a majority of the machine learning algorithms (e.g., the first and second subsets of the partition) and bias the next sample in such a manner as to deepen the understanding of this population. In this way, classified document partition (e.g., universal R, universal N, majority R, majority N, etc.) may continuously be enlarged while the size of dark matter population may be reduced through an iterative sampling.

In other embodiments, analysis module 114 may build machine learning models of the dark matter population only in the absence of the universal sets or the majority sets.

Those having ordinary skill in the art will recognize that computer 110 and client device 140 may each comprise one or more processors, one or more interfaces (to various peripheral devices or components), memory, one or more storage devices, and/or other components coupled via a bus. The memory may comprise random access memory (RAM), read only memory (ROM), or other memory. The memory may store computer-executable instructions to be executed by the processor as well as data that may be manipulated by the processor. The storage devices may comprise floppy disks, hard disks, optical disks, tapes, or other storage devices for storing computer-executable instructions and/or data.

One or more applications, including various modules, may be loaded into memory and run on an operating system of computer 110 and/or client device 140. In some embodiments, computer 110 and client device 140 may each comprise a server device, a desktop computer, a laptop, a cell phone, a smart phone, a Personal Digital Assistant, a pocket PC, or other device.

Network 102 may include any one or more of, for instance, the Internet, an intranet, a PAN (Personal Area Network), a LAN (Local Area Network), a WAN (Wide Area Network), a SAN (Storage Area Network), a MAN (Metropolitan Area Network), a wireless network, a cellular communications network, a Public Switched Telephone Network, and/or other network.

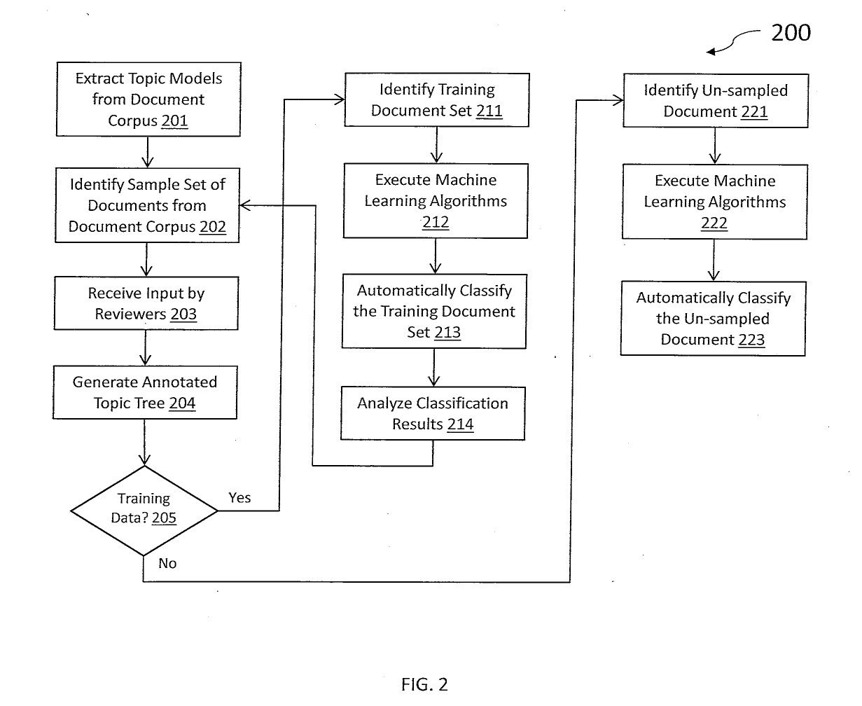

FIG. 2 illustrates a process 200 for automatically classifying documents using an annotated topic tree and analyzing the results of the automated classification, according to an embodiment. The various processing operations and/or data flows depicted in FIG. 2 (and in the other drawing figures) are described in greater detail herein. The described operations may be accomplished using some or all of the system components described in detail above and, in some embodiments, various operations may be performed in different sequences and various operations may be omitted. Additional operations may be performed along with some or all of the operations shown in the depicted flow diagrams. One or more operations may be performed simultaneously. Accordingly, the operations as illustrated (and described in greater detail below) are exemplary by nature and, as such, should not be viewed as limiting.

In an operation 201, process 200 may include obtaining topic models by extracting a set of topics from a document corpus such that each document in the document corpus is associated with a topic model. In an operation 202, process 200 may include identifying a sample set of document from the document corpus.

In an operation 203, process 200 may include receiving coding information from a human reviewer who may annotate each of the documents from the sample set with coding information. The coding information may include responsiveness, non-responsiveness, arguably responsiveness, null, and/or other codes for each document. For example, if a human reviewer determines that a particular document is responsive, the document and/or the corresponding topic model (and each of the topics in the topic list) may be annotated with ‘responsive.’

In an operation 204, process 200 may include transforming the annotated topic model to an annotated topic tree. Process 200 may label each node (e.g., each topic prefix) of the topic tree with the coding information provided by the human reviewer. The coding information provided by the human reviewer may be applied to the topic tree such that each topic prefix of the topic tree may be labeled with a tuple of numbers that indicate how many documents with the particular topic prefix in the sample set are coded for ‘responsive’, ‘non-responsive’, ‘arguably responsive’, ‘null’, etc.

In an operation 205, process 200 may include determining whether training data is needed. If process 200 determines that the training data is needed, process 200 may proceed to an operation 211. In operation 211, process 200 may include identifying suitable sets of training documents.

In an operation 212, process 200 may include executing one or more machine learning algorithms over the training document sets based on the annotated topic tree generated in operation 204. Process 200 may include applying a combination of a plurality of machine learning algorithms to the training document sets based on a selected voting algorithm. In some embodiments, each of the plurality of machine learning algorithms may represent one voting classifier in a voting algorithm. For example, if 5 different machine learning algorithms are used for classification, a voting algorithm may include 5 voting classifiers where each voting classifier may get one vote. The plurality of machine learning algorithms may include the one or more machine learning algorithms that may be run based on an annotated topic tree, as discussed herein. In addition, the plurality of the machine learning algorithms may include various machine learning techniques such as Stochastic Gradient Descent, Random Forests, complementary Naïve Bayes, Principal Component Analysis, Support Vector Machines (SVM), and/or other well-known machine learning algorithms, as apparent to those skilled in the art.

In an operation 213, process 200 may include automatically classifying the training document sets based on the machine learning algorithms executed in operation 212. In an operation 214, process 200 may include analyzing the classification results of the training data sets in order to update or otherwise tune the one or more machine learning algorithms over an iterative succession of sampling. Process 300 may return to operation 202 to determine the next sample set based on the analysis in such a manner as to enhance the performance of the automated classification.

On the other hand, if process 200 determines in operation 205 that a sufficient amount of training data has been developed, process 200 may proceed to an operation 221. In operation 221, process 200 may include identifying un-sampled documents in the document corpus.

In an operation 222, process 200 may include executing one or more machine learning algorithms over the un-sampled documents based on the annotated topic tree generated in operation 204. Process 200 may include applying a combination of a plurality of machine learning algorithms to the un-sampled documents based on a selected voting algorithm. In some embodiments, each of the plurality of machine learning algorithms may represent one voting classifier in a voting algorithm. For example, if 5 different machine learning algorithms are used for classification, a voting algorithm may include 5 voting classifiers where each voting classifier may get one vote. The plurality of machine learning algorithms may include the one or more machine learning algorithms that may be run based on an annotated topic tree, as discussed herein. In addition, the plurality of the machine learning algorithms may include various machine learning techniques such as Stochastic Gradient Descent, Random Forests, complementary Naïve Bayes, Principal Component Analysis, Support Vector Machines (SVM), and/or other well-known machine learning algorithms, as apparent to those skilled in the art.

In an operation 223, process 200 may include automatically classifying the un-sampled documents based on the machine learning algorithms executed in operation 222.

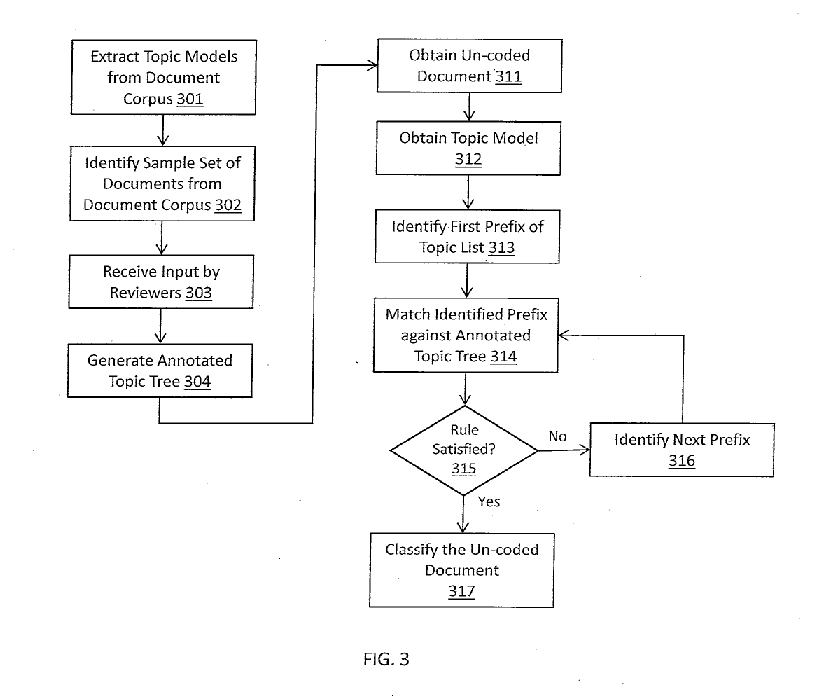

FIG. 3 illustrates a process 300 for automatically classifying documents using an annotated topic tree, according to an embodiment. In an operation 301, process 300 may include obtaining topic models by extracting a set of topics from a document corpus such that each document in the document corpus is associated with a topic model.

In an operation 302, process 300 may include identifying a sample set of documents from the document corpus. In an operation 303, process 300 may include receiving coding information from a human reviewer who may annotate each of the documents from the sample set with coding information. The coding information may include responsiveness, non-responsiveness, arguably responsiveness, null, and/or other codes for each document. For example, if a human reviewer determines that a particular document is responsive, the document and/or the corresponding topic model (and each of the topics in the topic list) may be annotated with ‘responsive.’

In an operation 304, process 300 may include transforming the annotated topic model to an annotated topic tree. Process 300 may label each node (e.g., each topic prefix) of the topic tree with the coding information provided by the human reviewer. The coding information provided by the human reviewer may be applied to the topic tree such that each topic prefix of the topic tree may be labeled with a tuple of numbers that indicate how many documents with the particular topic prefix in the sample set are coded for ‘responsive’, ‘non-responsive’, ‘arguably responsive’, ‘null’, etc.

In an operation 311, process 300 may include obtaining one or more documents (“un-coded documents”) to be classified. The one or more un-coded documents may include documents in the document corpus not included in the sample set (“un-sampled document”), training document sets, and/or other documents. In an operation 312, process 300 may include obtaining and/or identifying a topic model for each un-coded document, which associates each un-coded document with one or a set of relevant topics (“topic list”) where a topic list may include a list of relevant topics ordered by topic weight (e.g., decreasing topic weight).

In an operation 313, process 300 may include identifying the highest weighted topic (e.g., the first topic prefix) in the topic list of each un-coded document. In an operation 314, process 300 may include matching the identified topic prefix against the corresponding topic prefix in the annotated topic tree. In an operation 315, process 300 may include determining whether the corresponding topic prefix has a rule associated with it and the conditions of the rule (if any) are satisfied. If process 300 determines that there is no rule associated with the corresponding topic prefix or not all of the conditions of the rule have been satisfied, process 300 may proceed to an operation 316.

In operation 316, process 300 may include identifying the next topic prefix (e.g., the second topic prefix) of the un-coded document and process 300 may return to operation 314 to match the identified topic prefix (e.g., the second topic prefix) against the corresponding topic prefix in the coded topic tree model. On the other hand, if process 300 determines that the conditions of the rule have been satisfied, process 300 may proceed to the next operation.

In an operation 317, process 300 may include automatically classifying the un-coded document by assigning the document to a particular code according to the rule.

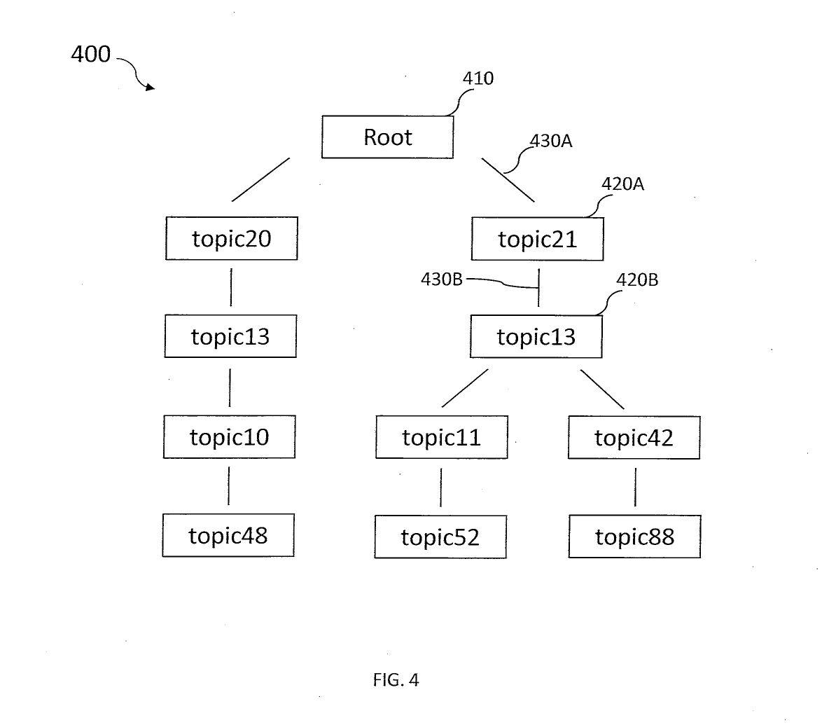

FIG. 4 illustrates an exemplary topic tree 400, according to an embodiment. Referring to FIG. 4, topic tree 400 may include a ROOT 410, nodes 420, and/or edges 430. Two nodes such as nodes 420A and 420B may be connected by an edge. A path may represent any connected sequence of edges. A “prefix path” may be a path from the ROOT to any node below it. For example, node 420B may be associated with a prefix path that is a sequence of edges 420A and 420B, which may be represented as “|21|13” where each line represents an edge in the topic tree.

Other embodiments, uses and advantages of the invention will be apparent to those skilled in the art from consideration of the specification and practice of the embodiments disclosed herein. The specification should be considered exemplary only, and the scope of the embodiments is accordingly intended to be limited only by the following claims.

What is claimed is:

1. A method for automatically classifying documents using an annotated topic tree, the method being implemented in a computer that includes one or more processors configured to execute one or more computer program modules, the method comprising:
obtaining, by a topic model module, topic models associated with individual documents of a document corpus, the document corpus comprising a plurality of documents;
identifying, by a sampling module, a sample set of documents from the document corpus;
generating, by the sampling module, an annotated topic tree based on the topic models associated with the sample set and coding information, wherein the coding information is determined based on user input that manually classifies individual documents of the sample set; and
projecting, by a projection module, information related to the annotated topic tree to one or more un-coded documents in the document corpus.

2. The method of claim 1, wherein the annotated topic tree comprises one or more nodes, wherein a node is denoted by a corresponding topic prefix.

3. The method of claim 1, the method further comprising:
identifying, by the projection module, a first topic prefix of a topic model associated with an un-coded document, the first topic prefix comprising a first highest weighted topic of the topic model associated with the un-coded document;
comparing, by the projection module, the first topic prefix against the annotated topic tree;
identifying, by the projection module, a corresponding topic prefix in the annotated topic tree based on the comparison; and
determining, by the projection module, whether a rule associated with the corresponding topic prefix classifies the un-coded document; and
automatically classifying, by the projection module, the un-coded document based on determination.

4. The method of claim 3, the method further comprising:
determining, by the projection module, that the rule classifies the un-coded document; and
automatically classifying, by the projection module, the un-coded document based on the rule.

5. The method of claim 3, the method further comprising:
determining, by the projection module, that the rule does not classify the un-coded document;
identifying, by the projection module, a second topic prefix of the topic model associated with the un-coded document, the second topic prefix comprises the first highest weighted topic and a second highest weighted topic of the topic model associated with the un-coded document;
comparing, by the projection module, the second topic prefix against the annotated topic tree;
identifying, by the projection module, a corresponding topic prefix in the annotated topic tree based on the comparison;
determining, by the projection module, whether a rule associated with the corresponding topic prefix classifies the un-coded document; and
automatically classifying, by the projection module, the un-coded document based on determination.

6. The method of claim 1, wherein the coding information includes a plurality of codes assigned to a same document in the sample set, the method further comprising:
determining, by the sampling module, whether the plurality of codes assigned to the same document are different from one another; and
obtaining, by the sampling module, coding information for the same document based on determining that the plurality of codes assigned to the same document are different from one another, wherein the coding information is used to resolve differences in the plurality of codes assigned to the same document.

7. A method for automatically classifying documents based on a voting algorithm, the method being implemented in a computer that includes one or more processors configured to execute one or more computer program modules, the method comprising:
obtaining, by a topic model module, topic models associated with individual documents of a document corpus, the document corpus comprising a plurality of documents;
identifying, by a sampling module, a sample set of documents from the document corpus;
obtaining, by the sampling module, coding information related to the sample set, wherein the coding information is determined based on user input that manually classifies the individual documents of the sample set;
executing, by a projection module, a plurality of machine learning algorithms on one or more un-coded documents in the document corpus;
selecting, by the projection module, a voting algorithm, the voting algorithm comprising a plurality of voting classifiers, wherein each of the plurality of voting classifiers corresponds to individual ones of the plurality of machine learning algorithms; and
automatically classifying, by the projection module, the one or more un-coded documents based on the selected voting algorithm.

8. The method of claim 7, the method further comprising:
obtaining, by an analysis module, results of automated classification of the one or more un-coded documents;
analyzing, by the analysis module, the results based on the selected voting algorithm; and
determining, by the sampling module, a next sample set of documents based on the analysis of the results.

9. The method of claim 7, wherein executing the plurality of machine learning algorithms on one or more un-coded documents in the document corpus further comprises:
generating, by the sampling module, an annotated topic tree based on the topic models associated with the sample set and the coding information; and
projecting, by a projection module, information related to the annotated topic tree to the one or more un-coded documents in the document corpus.

10. The method of claim 7, wherein the plurality of machine learning algorithms comprises Stochastic Gradient Descent, Random Forests, complementary Naive Bayes, Principal Component Analysis, and/or Support Vector Machines.

11. A system for automatically classifying documents using an annotated topic tree, the system comprising:
one or more processors configured to execute computer program modules, the computer program modules comprising:
a topic model module configured to:
obtain topic models associated with individual documents of a document corpus, the document corpus comprising a plurality of documents; determine a sample set of documents from the document corpus;
a sampling module configured to:
identify a sample set of documents from the document corpus;
generate an annotated topic tree based on the topic models associated with the sample set and coding information, wherein the coding information is determined based on user input that manually classifies individual documents of the sample set; and
a projection module configured to:
project information related to the annotated topic tree to one or more un-coded documents in the document corpus.

12. A system for automatically classifying documents based on a voting algorithm, the system comprising:
one or more processors configured to execute computer program modules, the computer program modules comprising:
a topic model module configured to:
obtain topic models associated with individual documents of a document corpus, the document corpus comprising a plurality of documents;
a sampling module configured to:
identify a sample set of documents from the document corpus;
obtain coding information related to the sample set, wherein the coding information is determined based on user input that manually classifies the individual documents of the sample set;
a projection module configured to:
execute a plurality of machine learning algorithms on one or more un-coded documents in the document corpus;
select a voting algorithm, the voting algorithm comprising a plurality of voting classifiers, wherein each of the plurality of voting classifiers corresponds to individual ones of the plurality of machine learning algorithms; and
automatically classify the one or more un-coded documents based on the selected voting algorithm,
